(19) United States
(12) Patent Application Publication
(10) Pub. No.: US 2012/0310377 A1
(43) Pub. Date: Dec. 6, 2012

(54) OPTIMIZED UTILITIES CONSUMPTION

(75) Inventors: Gregory A. Prentice, Snoqualmie, WA (US); Michaeljon Miller, Bellevue, WA (US)

(73) Assignee: Microsoft Corporation, Redmond, WA (US)

(21) Appl. No.: 13/118,606

(22) Filed: May 31, 2011

(51) Int. Cl. G05B 13/02; G06Q 40/00

(52) U.S. Cl. 700/36; 705/412; 705/400

(57) ABSTRACT

A utility consumption optimization mechanism may determine an optimized period for consuming a utility based on several input parameters and several constraints. The optimization mechanism may determine an optimum consumption time and cause a device to consume the utility during that time. A schema may define various parameters that may be passed to a rate calculation mechanism, and the optimization mechanism may use the rate calculation mechanism to find an optimized consumption schedule for a particular application. The optimization mechanism may be implemented as an embedded controller in a consuming device, as a web service that may be available through an Internet connection, or in other embodiments.

### BACKGROUND

Power, water, and other utilities may have many different factors that contribute to the cost of the utilities. In some locations for example, electricity may be supplied on a tiered pricing scheme where electricity costs may be highest during periods of high demand, such as during the day in summertime. At night, the electricity costs may be lower due to the lower demand.

### SUMMARY

A utility consumption optimization mechanism may determine an optimized period for consuming a utility based on several input parameters and several constraints. The optimization mechanism may determine an optimum consumption time and cause a device to consume the utility during that time. A schema may define various parameters that may be passed to a rate calculation mechanism, and the optimization mechanism may use the rate calculation mechanism to find an optimized consumption schedule for a particular application. The optimization mechanism may be implemented as an embedded controller in a consuming device, as a web service that may be available through an Internet connection, or in other embodiments.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with a utility cost calculation system.

FIG. 2 is a timeline illustration of an embodiment showing a method for operating a device with input from a utility calculation.

### DETAILED DESCRIPTION

A utility consumption management system may optimize utility consumption to minimize price or other factors by analyzing a tariff structure and various options and constraints. The management system may determine an optimized utility consumption schedule and cause one or more devices to operate according to the utility consumption schedule.

In one use scenario, an electric automobile may be recharged by purchasing electricity from a utility. Because the utility may have a complex tariff structure that may vary with the time of day, quantity of energy consumed, maximum and minimum consumption rates, seasonality, pricing tiers, and other factors, the utility consumption management system may determine an optimized consumption schedule for recharging the electric vehicle.

In another use scenario, a dishwasher in a consumer's home may be configured to consume water from a water utility and discharge waste water into a sewage utility. Both the water utility and the sewage utility may have various tariff structures that may vary with the time of day, available supply and demand, and other factors, which may include demands by other consumers for similar utilities. The utility consumption management system may determine an optimized consumption schedule for operating the dishwasher and may cause the dishwasher to operate on a schedule that optimizes the utility capacities.

In still another use scenario, a computing device may execute an application that may consume network bandwidth. The application may not be time sensitive and may use the utility consumption management system to determine an optimized schedule for consuming network bandwidth from multiple network provider or communication utilities. The utility consumption management system may evaluate pricing structures from several network bandwidth provider utilities to select a lowest cost option and determine a usage schedule. The application may operate according to the usage schedule to consume the network bandwidth at a lowest cost.

In yet another use scenario, a home or building automation controller may contain a utility consumption management system that may determine an optimized usage schedule for various appliances, lighting, heating, air conditioning, irrigation, and other utility consuming systems within a residence, business, or other building.

In still another use scenario, a consumer may use a utility consumption management system to determine an optimized schedule to purchase propane, heating oil, water, or other consumable item purchased from a utility that may be stored by the consumer. The consumer may enter a projected consumption profile and a projected pricing profile to determine an optimized schedule for purchasing and storing the consumable item.

The utility consumption management system may construct a calculated utility pricing structure that may define the various rules for calculating costs for consuming a utility. The calculated utility pricing structure may be used to optimize the pricing for a particular use scenario. The optimized pricing may result in a consumption schedule that minimizes the cost of the utility to the consumer.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

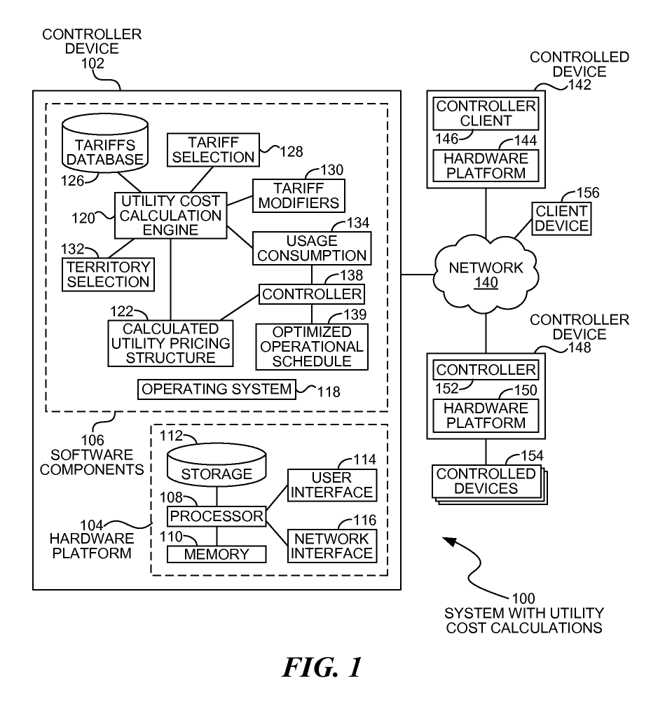

FIG. 1 is a diagram of an embodiment 100, showing a system that may include a utility cost calculation mechanism. Embodiment 100 is an environment in which utility cost calculations may be used to control various devices to minimize utility expenses.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 is a simplified example of an environment that may be found in a datacenter or in another type of large application processing environment. The environment may have many devices that may be performing a similar workload.

Embodiment 100 illustrates an environment in which utility cost calculations may be used to control or effect how various devices function. In many cases, a consumer may have options or flexibility in how a specific utility may be consumed. For example, a device that may be recharged with electricity may be recharged when the electricity rates are lowest. A consumer may desire to have the device recharged during the evening times, but may not care when the actual recharging occurs, provided that the device is recharged at a designated time.

Some embodiments may have an optimization mechanism that may determine an optimized use schedule, where the optimized use schedule may fit the constraints of a usage consumption profile while minimizing costs. A device controller may consume the optimized use schedule to operate a device to minimize costs.

In many utilities, a complex pricing structure may be one mechanism by which a utility may influence the supply and demand of the utility. Higher prices may reflect a decrease in supply with an increase in demand. The higher prices may discourage use during periods of low supply, and lower prices may encourage use during periods of high supply. By using a complex pricing structure, many utilities may attempt to smooth out demand fluctuations and may better utilize the utility infrastructure.

The utilities may refer to any type of commodity that may be purchased on an ongoing basis. In some cases, the utilities may be a commodity such as electricity, natural gas, propane, heating oil, water, sewer services, telephone services, network bandwidth, or other conventional utilities. In some embodiments, the utilities may include other commodities, such as raw goods consumed by a manufacturer, services consumed by a business or residence, or other items.

The utility cost system may operate on a controller device 102. The device 102 is illustrated having hardware components 104 and software components 106. The controller device 102 as illustrated represents a conventional computing device, although other embodiments may have different configurations, architectures, or components.

In many embodiments, the controller device 102 may be a personal computer or code development workstation. The controller device 102 may also be a server computer, desktop computer, or comparable device. In some embodiments, the controller device 102 may still also be a laptop computer, netbook computer, tablet or slate computer, wireless handset, cellular telephone, or any other type of computing device. In still other embodiments, the controller device 102 may be a cloud computing service or other service available over a network connection.

The hardware components 104 may include a processor 108, random access memory 110, and nonvolatile storage 112. The hardware components 104 may also include a user interface 114 and network interface 116. The processor 108 may be made up of several processors or processor cores in some embodiments. The random access memory 110 may be memory that may be readily accessible to and addressable by the processor 108. The nonvolatile storage 112 may be storage that persists after the device 102 is shut down. The nonvolatile storage 112 may be any type of storage device, including hard disk, solid state memory devices, magnetic tape, optical storage, or other type of storage. The nonvolatile storage 112 may be read only or read/write capable.

The user interface 114 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 116 may be any type of connection to another computer. In many embodiments, the network interface 116 may be a wired Ethernet connection. Other embodiments may include wired or wireless connections over various communication protocols.

The software components 106 may include an operating system 118 on which various applications and services may operate. An operating system may provide an abstraction layer between executing routines and the hardware components 104, and may include various routines and functions that communicate directly with various hardware components.

The software components 106 may include a utility cost calculation engine 120 that may create a calculated utility pricing structure 122. The calculated utility pricing structure 122 may include various rules that define how the utility pricing may be determined. A controller 138 may consume the calculated utility pricing structure 122 to determine an optimized operational schedule 139. The controller 138 may operate a device or cause a device to operate using the optimized operational schedule 139.

The calculated utility pricing structure 122 may be created by an engine 120 that may consume tariffs from a tariff database 126, a selected tariff 128, various tariff modifiers 130, as well as a territory selection 132 and a predicted usage consumption 134. The calculated utility pricing structure 122 may be defined in a manner that may be consumed by various applications.

The calculated utility pricing structure 122 may be defined in a data structure or schema, such as XSD, that include various components. An example schema may include the following items:

pricingSourceType—The pricingSourceType may define the quality of the price delivered by a notification. Within the pricingSourceType, there may be several modifiers: UtilityTariffs—may signal that the pricing information may be of high quality. UtilityNotification—may signal that the pricing information may be of high quality. UtilityInvoiceAverages—may signal that the pricing information may be a precalculated average based off of historical pricing from a customer's utility invoices.

The pricingSourceType may also include: CustomerAverages—that may signal that the pricing information may be a pre-calculated average based on historical rates from a single customer's invoices. The CustomerAverages may be based on invoices received from the utility company. Such an approach may be used when tariff information may have not been provided and the customer's tariff code and schedules may be unknown. The quality of this price may be as good as information entered by a specific customer, and may be subjective to the information they have manually entered.

The pricingSourceType may further include: ChargingStation—that may signal that the pricing information is of the best quality, as well as AreaAverages—that may signal that the pricing information may be based on a precalculated average from historical rates for a given location.

In some cases, the pricingSourceType may include a modifier of: None—that may signal that the pricing information cannot be determined and any price should be ignored.

pricingInfoType—The pricingInfoType may provide additional context regarding the price delivered by a notification. The pricingInfoType may include: Increase—The delivered rate may be an increase in pricing. Decrease—The delivered rate may be a decrease in pricing.

The pricingInfoType may include a ConditionalDecrease. The ConditionalDecrease may define that a decrease in price may occur. An example of a conditional decrease event may be where a utility tariff specifies a potential savings may apply when a utility customer can decrease their energy usage by 20 percent of their average daily consumption. Since this amount may be calculated in the future, the price may depend on a future event which is not known. Similarly, the pricingInfoType may include ConditionalIncrease. ConditionalIncrease may indicate that an increase in price may occur. An example of a conditional increase event occurs where the utility tariff specifies an increase in price will apply if a utility customer fails to reduce their consumption by more than 20 percent of their average daily consumption.

The pricingInfoType may include Unknown, which may define that a pricing change may have occurred but cannot determine if it is an increase or decrease.

pricingConfidenceType—Defines a level of confidence in the price reported. The pricingConfidenceType may include High, which may indicate that the price being given is the best quality and was calculated from a utility rate definition. Medium—The price being given is a good quality price, and was calculated from a utility rate definition but may not have had enough information about the energy consumer or their generational percentages to fully calculate the price. Low—The price being given generally may be some type of area average from an outside source, based off of a user's invoice averaging or provided by the utility company.

pricingType—Defines a notification base that may allow new pricing information to be delivered. Generally a pricing change may occur due to a temporary increase related to supply and demand or a customer crosses a tier boundary.

seasonType—Some utility seasons may be defined as winter and summer, which may in turn define different pricing structures. The seasonType may allow one or more pricing structures to be defined and used during a tariff's effective dates.

tierPricingType—Tier pricing may define a rate that is applied to the energy used based on the total amount of energy used during a customer's billing cycle.

touPricingType—may define the rate used for a particular time-of-use (tou) delineated by the start and end time.

touTierPricingType—may define the rate used for a particular tier pricing combined with a tou (time of use) pricing delineated by a effectiveFrom and effectiveTo time.

daysOfWeekType—may define a list of days that a particular rate applies. An example is where different rates apply during the weekdays than the weekends. In some embodiments, daysOfWeekType may represent Sunday as 0, Monday as 1, through Saturday as 6.

holidayType—may define an effective date and price for a flat rate. In some embodiments, the effective date may not be an actual holiday as each tariff may define special rules for things such as a weekend. For example, when a holiday lands on a Sunday, which may be off peak all day, the holiday may be rolled to the following Monday and apply holiday pricing for that day.

flatPricingType—may define a flat rate applied towards each unit consumed.

tierPricingListType—may define a list of one or more tier rates.

touPricingListType—may define a list of one or more time of use rates or time of user tiered rates.

flatPricingListType—may define a list of one or more flat rates.

rateType—may define different pricing structures that may be applied to different seasons.

meterRateType—may define a pricing structure that may be associated with a meter that may track the quantity used.

geocodedRateType—may define a single rate returned for a geocoded location.

The tariff database 126 may have various tariff definitions. The tariff database 126 may include the following parameters in its schema:

adjustment—may define an adjustment to the final price per unit of energy before the calculation. Example a price of 0.025 and an adjustment of −0.05 means 0.20 multiplies by a quantity.

baseline—may define an energy usage that may be multiplied times the number of days in a month to calculate a baseline or maximum energy consumed before a customer moves into the next pricing tier.

cyclicalFee—may define a charge that may occur on a reoccurring basis. For example, some commercial companies may be charged a monthly or bi-monthly meter fee that may be represented as a charge on a billing cycle. In some cases, this element can represent a onetime charge.

charge—may define the price applied during the calculations of the pricing structure.

defaultGeneration—may define a default percentage of the specified rate to use when calculating the total charge per unit of measure. The percentage may be tied to a specific location and rate code. This parameter may be used when seasonal generation has not been defined.

description—may define a text field used to provide a definition of an element.

exceptions—may define a day of the week that a holiday may occur and the conditional day of the week the holiday may be observed.

excludeRate—may define a default rate, but may be excluded when an exclusion code may be provided, in which case the excludeRate may be ignored.

fixedHoliday—may define a holiday that may occur on a specific Month and Day. Example would be the fourth of July which signifies the United States' celebration of Independence Day.

flatPricing—may define a list of flat rate pricing per unit.

flatRate—may define a flat rate price per unit.

floatingHoliday—may defines a holiday that may occur in a specific month but not a specific month and day. The actual day may be determined by specifying the occurrence of a day of the week. For example, the Fourth Thursday in November may signify the United States' celebration of Thanksgiving.

generation—may define a default percentage of the specified rate to use when calculating the total charge per unit of measure. This percentage may be tied to a specific location and rate code.

holiday—may define the holiday rates applied to a holiday.

holidays—may define the holidays for all tariffs included in this area.

includeRate—may define a specific rate for an inclusion code and may not apply to all customers. This rate may be applied when a consumer has one of the inclusion codes.

option—may define a way to add name value pairs that set specific state in regards to the calculation of utility rates. The option may provide an un-typed approach to add new options that may not use new schema definitions.

rate—may define details and pricing for a specific rate that may be referenced by the season pricing information, such as tiers, time of use, flat pricing, or other rate information.

rateCalculations—may define different pricing structures for different utility seasons.

reference—may define a reference to another rate definition and may be used to create a grouping of similar charges into one referenced rate. The reference may allow references to a rate in another tariff definition.

rules—may define the set of inclusion, exclusion, or substitution codes exercised against a rate.

season—may define a season for pricing that may vary for season.

seasonReference—may define territory specific settings that may be affected by the seasons as defined in the tariff element.

serviceAreaCountries—may define a list of service areas which may be defined by country.

serviceCountry—may define a specific country service area.

subRate—may define the set of sub rates that may define a price.

subRateReference—may define details for a specific sub rate that may be referenced by season pricing information, such as tiers, TOU, flat pricing, or other rate information.

substituteRate—may define a substitute rate that may be used in place of a current rate. If a substitute rate may be encountered, other rules relating to a standard rate may be ignored.

tariff—may define a list of tariffs that may be used in the calculations of utility pricing.

territory—may define a baseline energy usage amount that may be used for calculating different tiers. Generally baselines may be associated with territories and may be different for each territory.

territories—may define a baseline energy usage amount that may be used for calculating different tiers. Generally baselines may be associated with territories and may be different for each territory.

tier—may define a rate that may be applied to energy used based on the total amount of energy used during a customer's billing cycle.

tierPricing—may define rates for pricing based on user consumption.

timeOfUse—may define a rate used for a particular time of use delineated by a start and end time.

timeOfUseTier—may define a rate used for a particular tier pricing combined with a time of use pricing delineated by a effectiveFrom and effectiveTo time.

touPricing—may define rates for pricing based on user time of use and may also contain tiered pricing in conjunction with a time of use.

After a calculated utility pricing structure 122 has been created using the tariff database 126, tariff selection 128, various tariff modifiers 130, and a territory selection 132, a controller 138 may create an optimized operational schedule 139.

The optimized operational schedule 139 may define when a device may consume a utility. The controller 138 may then cause the device to operate according to the optimized operational schedule 139.

In some embodiments, the operations of the controller 138 may reside in the device that may consume the optimized operational schedule 139. In some such embodiments, the operations of the engine 120 may also reside in the same device.

For example, a rechargeable electric vehicle may have utility cost calculation engine 120 and controller 138 embedded into the vehicle. The vehicle may be able to identify many of the tariff sections 128, tariff modifiers 130, and territory selection 132, and may be able to identify an optimized operational schedule 139 for recharging the electric vehicle.

In some embodiments, various components may be connected by a network 140, which may be a local area network, a wide area network, the Internet, or any other network.

In some such embodiments, a controlled device 142 may be controlled by the controller device 102, which may determine the optimized operational schedule 139. In an example, the controlled device 142 may be a rechargeable electric vehicle, and the controller device 102 may be a web service or other service provider available over the network 140. The controller device 102 may determine an optimized operational schedule 139 and may cause the controlled device 142 to execute the optimized operational schedule 139.

In some embodiments, a controller device 148 may have a hardware platform 150 and a controller 152. The controller 152 may send the tariff information to the controller device 102, which may process the tariff information and return a calculated utility pricing structure 122 to the controller 152. The controller 152 may then determine an optimized operational schedule.

The controller device 148 may then cause one or more controlled devices 154 to operate according to the optimized operational schedule.

In one use model, the controller device 148 may be a home or building automation manager. The controller device 148 may manage various controlled devices 154. The controlled devices 154 may be HVAC devices, appliances, indoor or outdoor lighting, irrigation systems, or any other controllable device.

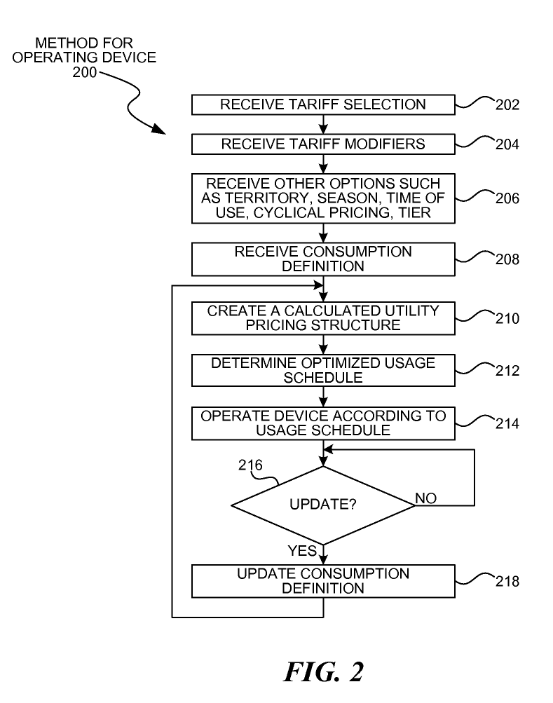

FIG. 2 is a flowchart illustration of an embodiment 200 showing a method for operating a device using a calculated utility pricing structure. The process of embodiment 200 is a simplified example of how a device may be operated using an optimized usage schedule with input from a utility pricing structure.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates a simple method for operating a device using a cost model for a utility and optimizing to minimize costs.

In block 202, a tariff selection may be received. The tariff selection may identify a relevant tariff, which may be accompanied by various tariff modifiers in block 204 and options in block 206. The tariff modified and options may include some or all of the options described in the schemas above.

In block 208, the utility consumption definition may be received. The utility consumption definition may define how much of the utility may be requested and any other parameters, such as maximum and minimum consumption rates, or other descriptors.

A calculated utility pricing structure may be determined in block 210. The calculated utility pricing structure may be defined according to the schema defined above, and may reflect the rules associated with the planned consumption of the utility.

An optimized usage schedule may be determined in block 212 from the calculated utility pricing structure. The optimized usage schedule may be determined by analyzing several different usage schedules, comparing the results, and identifying a lowest cost usage schedule.

Once the optimized usage schedule is determined in block 212, a device may be operated according to the usage schedule in block 214.

During the operation of the device, a decision may be made in block 216 to update the usage schedule. In such an event, the consumption definition may be updated in block 218 to reflect the current utility consumption demands and the process may return to block 210.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
receiving a calculated utility pricing structure defining rules for calculating costs of a utility, said calculated utility pricing structure being created from a tariff definition comprising a tariff, schedule, and rates for a utility;
receiving a utility consumption definition comprising a quantity of said utility and a usage date and time; and
calculating a utility cost from said calculated utility pricing structure and said utility consumption definition.

2. The method of claim 1, said calculated utility pricing structure comprising said utility consumption definition.

3. The method of claim 1 further comprising:
finding an optimized utility cost from said calculated utility pricing structure and said utility consumption definition.

4. The method of claim 3 further comprising:
said utility consumption definition being defined for energy consumption for a device; and
operating said device according to said optimized utility cost.

5. The method of claim 4, said device comprising a vehicle.

6. The method of claim 5, said vehicle being a rechargeable vehicle, said utility being an energy utility.

7. The method of claim 6, said method being performed by a controller within said vehicle.

8. The method of claim 3, said device comprising a computing resource, said utility being a network communications utility.

9. The method of claim 3, said utility being a water utility.

10. A system comprising:
a utility cost calculation engine that:
receives a calculated utility pricing structure defining rules for calculating costs of a utility, said calculated utility pricing structure being created from a tariff definition comprising a tariff, schedule, and rates for a utility;
receives a utility consumption definition comprising a quantity of said utility and a usage date and time; and
calculates a utility cost from said calculated utility pricing structure and said utility consumption definition;
a controller that:
determines said utility consumption definition for a device;
transmits said utility consumption definition to said utility cost calculation engine to receive a utility cost;
determines an optimized operational schedule for said device based on said utility cost; and
causes said device to be operated according to said optimized operational schedule.

11. The system of claim 10, said utility being one of a group composed of:
energy utility;
communication utility;
water supply utility; and
waste utility.

12. The system of claim 11, said controller being a web service accessible to said device.

13. The system of claim 11, said controller that further:
while said device is being operated according to said optimized operational schedule:
determines a remaining utility consumption definition for a device;
transmits said remaining utility consumption definition to said utility cost calculation engine to receive a second utility cost;
determines a second optimized operational schedule for said device based on said second utility cost; and
causes said device to be operated according to said second optimized operational schedule.

14. The system of claim 12, said device being an appliance within a residence.

15. The system of claim 12, said device being an HVAC device within a building.

16. The system of claim 10, said determines an optimized operational schedule being performed by:
identifying a first operational scenario comprising a first utility consumption definition and determining a first cost;
identifying a second operational scenario comprising a second utility consumption definition and determining a second cost; and
selecting one of said first operational scenario and said second operational scenario according to the lower of said first cost and said second cost.

17. The system of claim 10, said system being embedded in said device.

18. A method comprising:
receiving a calculated utility pricing structure defining rules for calculating costs of a utility, said calculated utility pricing structure being created from a tariff definition comprising a tariff, a schedule, a set of seasonal rates, and a set of location based rates for a utility;
receiving a utility consumption definition comprising a quantity of said utility and a usage date and time, said usage date and time being a range of time for consuming said utility; and
calculating an optimized utility consumption schedule from said calculated utility pricing structure and said utility consumption definition.

19. The method of claim 18, said utility consumption definition comprising a maximum consumption rate.

20. The method of claim 19, said utility consumption definition comprising a minimum consumption rate.
